(19) United States
(12) Patent Application Publication
(10) Pub. No.: US 2012/0199091 A1
(43) Pub. Date: Aug. 9, 2012

(54) HANDHELD WORK APPARATUS AND STARTER ARRANGEMENT FOR A HANDHELD WORK APPARATUS

(76) Inventor: Sebastian Bohling, Kernen (DE)

(21) Appl. No.: 13/367,819

(22) Filed: Feb. 7, 2012

(30) Foreign Application Priority Data
Feb. 7, 2011 (DE) 10 2011 010 494.1

(51) Int. Cl. F02N 1/00

(52) U.S. Cl. 123/185.3

(57) ABSTRACT

A work apparatus has an engine and a starter arrangement for the engine. The starter arrangement has an actuating unit and a coupling unit for connecting to a crankshaft of the engine. The actuating unit is rotatably mounted about a rotational axis. A coil spring is arranged between the actuating unit and the coupling unit. The spring has a contact surface in its region located radially inwardly in relation to the axis. At least one stub projects into the interior of the spring. The stub has a support surface in its region located radially outwardly relative to the axis. To achieve a comfortable actuating force, in the non-actuated state of the starter arrangement, a distance, which increases in size in the direction of the axis of the actuating unit, is formed between the contact surface and the support surface in a section of the spring.

### CROSS REFERENCE TO RELATED APPLICATION

This application claims priority of German patent application no. 10 2011 010 494.1, filed Feb. 7, 2011, the entire content of which is incorporated herein by reference.

### FIELD OF THE INVENTION

The invention relates to a handheld work apparatus and a starter arrangement for a handheld work apparatus.

### BACKGROUND OF THE INVENTION

U.S. Pat. No. 7,174,874 B2 discloses a starter arrangement which has a coil spring arranged between an actuation unit and a coupling unit. The coil spring is arranged on the outer periphery of a stub of the actuation unit. When the pull starter is pulled, the coil spring rests uniformly around the stub by way of its inner periphery. When the starter arrangement is actuated, the damping spring is initially tensioned until it lies fully around the stub of the actuating element. As soon as the coil spring positions itself around the stub the starter arrangement is connected to the crankshaft in a rotatably fixed manner so that the actuating force increases suddenly. To the operator, this is experienced as an unpleasant tug on the starter rope.

### SUMMARY OF THE INVENTION

It is an object of the invention to provide a handheld work apparatus which has a high degree of operating comfort when starting. It is a further object of the invention to provide a starter arrangement for the combustion engine of a handheld work apparatus with high degree of operating comfort.

The handheld work apparatus of the invention includes: a combustion engine having a crankshaft; a starter arrangement for starting the combustion engine; the starter arrangement having an actuating unit and a coupling unit configured to connect to the crankshaft of the combustion engine; the actuating unit defining a rotational axis and being rotatably mounted about the rotational axis; a dampening element configured as a coil spring defining a working direction and being arranged between the actuating unit and the coupling unit to operate in the working direction; the coil spring defining an interior and having an inner lying region referred to the rotational axis and the coil spring having a contact surface disposed at the inner region; a stub projecting into the interior of the coil spring and having a radially outer region referred to the rotational axis and the stub having a support surface at the outer region; the contact surface of the coil spring and the support surface of the stub conjointly defining a distance therebetween in at least one section of the coil spring when the starter arrangement is in a non-actuated state; and, the distance being configured to increase in the direction of the rotational axis of the actuating unit.

Because the distance between the contact surface of the coil spring and the support surface of the stub is not constant over the entire length of the coil spring, but rather increases in one direction, the coil spring comes gradually into contact with the support surface. As a result, the operating force does not increase suddenly, but rather a gradual force increase is achieved. As a result, the operating comfort is increased.

Advantageously, the distance from one end of the coil spring to the other end changes uniformly. Thus, a constant force increase is made possible. At the same time, the distance advantageously decreases from the end facing the coupling unit to the end facing the actuating unit. As a result, the coil spring first contacts the support surface by way of the end facing the actuating unit. Because the distance between the coil spring and the stub at the end facing the actuating unit is small or the coil spring also rests at this end against the stub in the non-actuated state of the starter arrangement, the radial distance, which the end of the coil spring facing the actuating unit covers when the starter arrangement is actuated, is small. Thus, the receptacle for the end of the coil spring facing the actuating unit can be configured with little play. In particular, the end of the coil spring facing the actuating unit is bent and hooked into a correspondingly bent receptacle on the actuating unit. Because of the small radial relative movement between the end of the coil spring and the receptacle, the end of the coil spring can be constructed with a relatively large bending radius. The large bending radius is made possible because hardly any space is required for the radial movement of the end of the coil spring and the available space is largely available for the bent end of the coil spring.

A simple configuration is achieved when the at least one stub is configured conically. Alternatively or additionally, the coil spring can also be wound conically. As a result, a uniformly changing distance is achieved in a simple manner. At the same time, the diameter of the coil spring advantageously increases from the end facing the actuation unit to the end facing the coupling unit. A simple configuration is achieved when the at least one stub is configured conically and the coil spring is wound cylindrically.

A simple configuration and good guidance of the coil spring are achieved when a first stub is arranged on the actuation unit and a second stub is arranged on the coupling unit. Advantageously, the support surface of the first stub and the support surface of the second stub are on a straight line in every sectional plane which contains the rotational axis. The support surface of the first stub thus transitions in a straight line into the support surface of the second stub. No step or ledge is formed between the support surfaces. The two support surfaces also run at the same angle. Thus, uniform contact between the coil spring and the support surfaces is achieved. If the support surfaces are formed by individual surface sections which are separate from each other, then support surface refers to the envelope curve on which the individual surface sections lie. Accordingly, a surface section need not actually be arranged in every sectional plane. A simple configuration is achieved when the first stub and the second stub butt against each other. It can, however, also be provided that a further element, which advantageously also has a support surface for the coil spring, is arranged between the two stubs.

A compact construction with good damping properties can be achieved when the coil spring has a rectangular wire cross-section. The rectangular wire cross-section enables a high spring constant in the case of little construction space. In particular, the coil spring is held with a first end on the actuation unit and with a second end on the coupling unit. As a result, an extremely uniform increase in the actuating force is achieved.

### BRIEF DESCRIPTION OF THE DRAWINGS

The invention will now be described with reference to the drawings wherein:

FIG. 1 is a schematic side view of a chain saw;

FIG. 2 is a schematic section view through the chain saw of FIG. 1;

FIG. 3 is an exploded view of the starter arrangement of the chain saw of FIG. 1;

FIG. 4 is an exploded view of the starter arrangement of the chain saw of FIG. 1;

FIG. 5 is a section view of an embodiment of the starter arrangement;

FIG. 6 is a section view of an embodiment of the starter arrangement; and,

FIG. 7 is a section view of an embodiment of the starter arrangement.

### DESCRIPTION OF THE PREFERRED EMBODIMENTS OF THE INVENTION

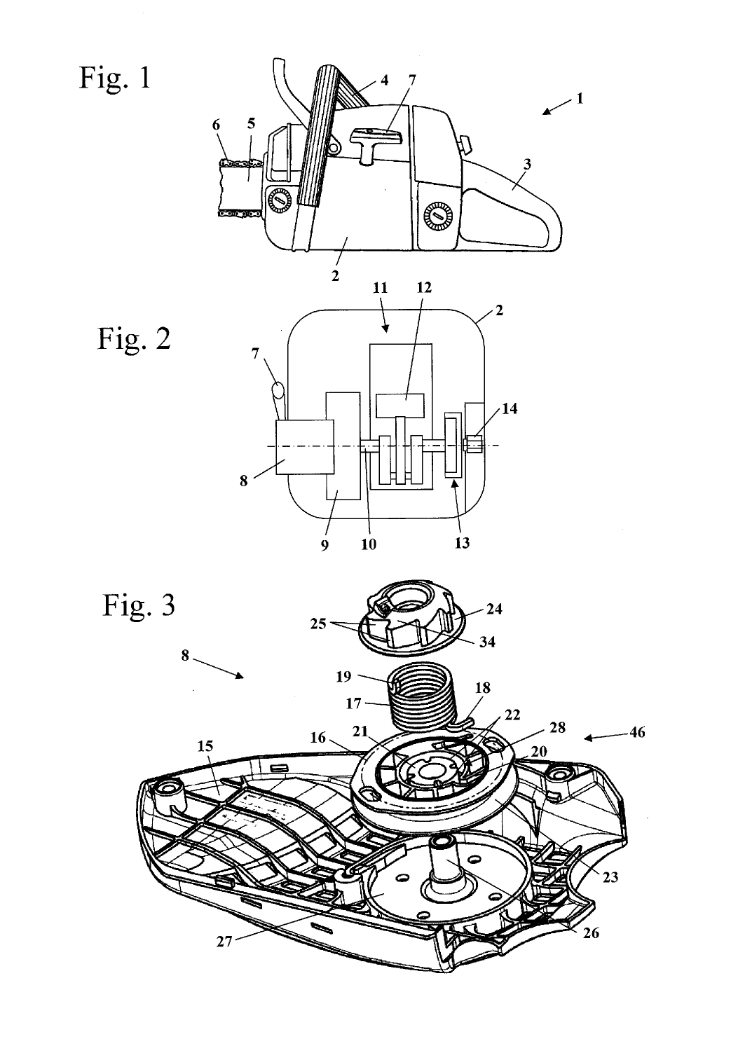

FIG. 1 shows a chain saw 1 as an example for a handheld work apparatus. The suggested starter arrangement can, however, also be used in other handheld work apparatus, such as a cut-off machine, a trimmer or the like. The chain saw 1 has a housing 2 on which a rear handle 3 and a bale handle 4 are arranged. A guide bar 5 projects forward from the end of the housing 2 which is opposite the rear handle 3, a saw chain 6 being arranged on the periphery of the guide bar 5. A starter handle 7 projects out of the housing 2.

The saw chain 6 is driven by a combustion engine 11, shown schematically in FIG. 2, which is arranged in the housing 2. For this purpose, a crankshaft 10 of the combustion engine 11 is connected via a centrifugal clutch 13 to a drive sprocket 14, around which the saw chain 6 is guided. As FIG. 2 also shows, the crankshaft 10 is driven by a reciprocating piston 12.

In order to start the combustion engine 11, the chain saw 1 has the starter arrangement 8, which is to be actuated by the operator via the start handle 7. Instead of being actuated via the start handle 7, the starter arrangement 8 can also be actuated electrically, for example via an electric motor. The starter arrangement 8 is connected with a fan wheel 9 via a coupling unit which is described in more detail below, the fan wheel 9 being arranged on the crankshaft 10 in a rotatably fixed manner.

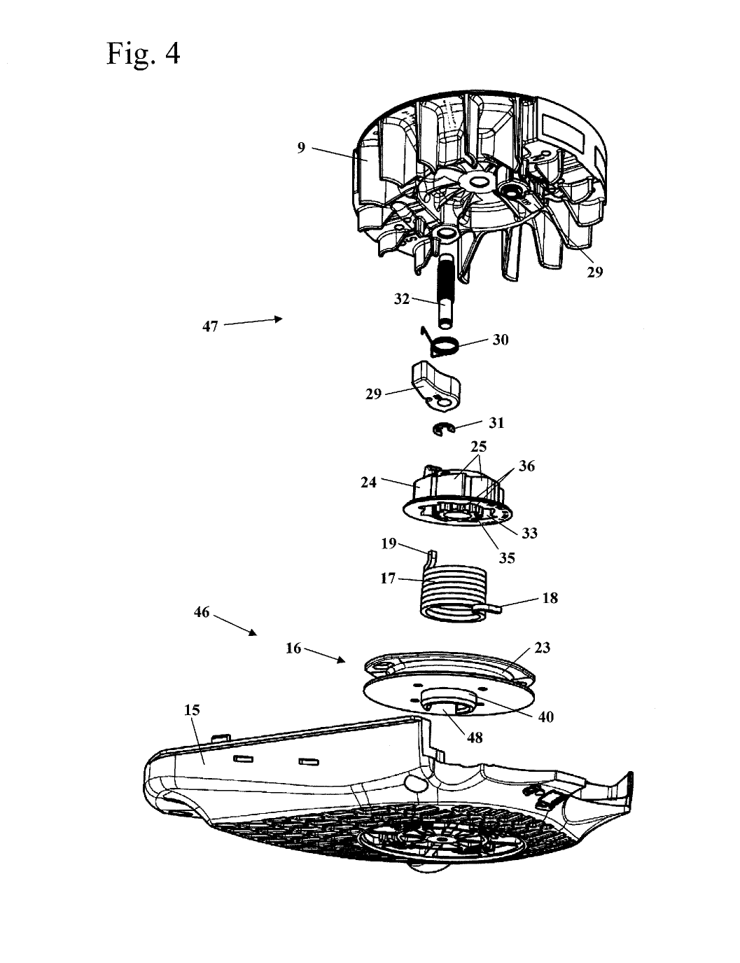

FIGS. 3 and 4 show the configuration of the starter arrangement 8 in detail. The starter arrangement 8 is arranged on a fan wheel cover 15 which is part of the housing 2. The fan wheel cover 15 has a bearing shaft 26 on which the starter arrangement 8 is rotatably mounted. A receptacle space 27 for a return spring, not shown in FIGS. 3 and 4, is formed on the fan wheel cover 15. A rope drum 16, which is part of an actuating unit 46 of the starter arrangement 8, is arranged adjacent to the receptacle space 27 on the bearing shaft 26. A first stub 21, on the outer periphery of which a receptacle 28 for a coil spring 17 is formed, is formed on the rope drum 16. The coil spring 17 forms the damping element of the starter arrangement 8. The coil spring 17 has a first end 18, with which it is held on the rope drum adjacent to the receptacle 28. For this purpose, the rope drum 16 has a slot 20 in which the first end 18 is held in a form-fitting manner. A plurality of radially outwardly facing ribs 22 are arranged on the stub 21.

The second end 19 of the coil spring 17 projects away from the coil spring 17 in the axial direction. The starter arrangement 8 has an entrainer 24 which is part of the coupling unit 47 (FIG. 4) for connecting to the fan wheel 9. The entrainer 24 has an opening 34 into which the second end 19 of the coil spring 17 can be inserted and is thus connected to the entrainer 24 in a form-fitting manner. It can be provided that the entrainer 24 has multiple openings 34, so that multiple positions for the relative position of the coil spring 17 and the entrainer 24 with respect to each other are possible.

As FIGS. 3 and 4 show, the entrainer 24 has radially outwardly projecting teeth 25, which interact with pawls 29 pivotably mounted on the fan wheel 9. The pawls 29 are spring loaded by torsion springs 30 into their radially inwardly pivoted position. The pawls are pivotably mounted on bearing pins 32 and are secured in the axial direction by securing rings 31. When at standstill, the pawls 29 are pressed against the teeth 25 so that the entrainer 24 is connected to the fan wheel 9 so as to rotate therewith in one rotational direction. In the opposite direction, the pawls 29 can slide over the teeth 25. As soon as the combustion engine 11 is running the fan wheel 9 can outrun the entrainer 24. When a constructively predetermined rotational speed is exceeded, the pawls 29 pivot radially outward as a result of centrifugal force, and so there is no longer a connection between the entrainer 24 and the fan wheel 9.

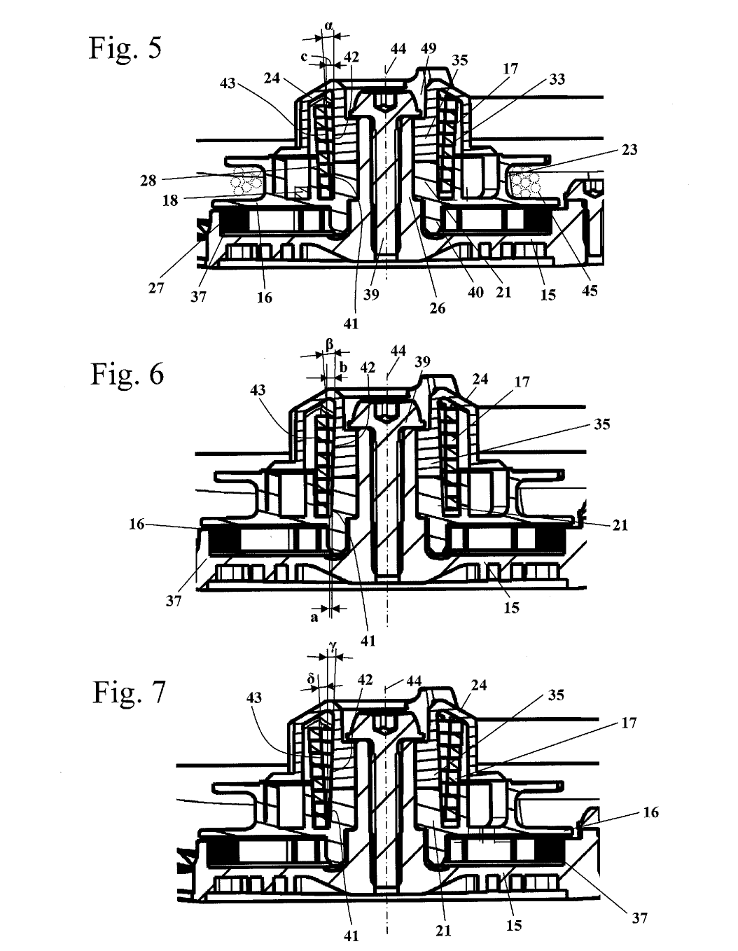

As FIG. 4 shows, the entrainer 24 has a receptacle 33 for the coil spring 17. In the receptacle 33, a stub 35 of the entrainer 24 projects and the coil spring 17 is arranged on the outer periphery of this stub. On its outer periphery, the stub 35 carries a plurality of ribs 36, which extend in the axial direction and radially outward. As FIG. 4 also shows, a groove 23 for receiving a starter rope 45, shown schematically in FIG. 5, is formed on the outer periphery of the rope drum 16. On the side facing the receptacle space 27, the rope drum 16 has an edge 40 which is configured in an annular manner and has an open region 48. The return spring 37 shown in FIG. 5, which is configured as a helical spring, can be hooked in at the open region 48.

As FIG. 5 shows, the rope drum 16 largely closes the receptacle space 27 for the return spring 37. The entrainer 24 rests against the rope drum 16 and closes the interior space of the rope drum 16 to the outside. The rope drum 16 and the entrainer 24 are mounted on the bearing shaft 26. On its end facing the fan wheel 9, the entrainer 24 has a recess 49, on which the head of a screw 39, which holds the entrainer 24 on the bearing shaft 26, is arranged. The screw 39 is screwed into the fan wheel cover 15. A disc, which is secured in the axial direction by the head of the screw 39, can be provided to secure the entrainer 24.

As FIG. 5 shows, a support surface 41 is formed on the outer periphery of the stub 21. The support surface 41 is formed by surfaces of the ribs 22 which face radially outward in relation to the rotational axis 44 and is thus not a continuous cylindrical surface, but rather is formed from individual surface sections. Correspondingly, a support surface 42 is formed on the outer periphery of the stub 35 by the radially outwardly facing surfaces of the ribs 36. The support surfaces 41 and/or 42 can, however, also be configured as continuous cylindrical or conical surfaces. The coil spring 17 is arranged on the outer periphery of the support surfaces 41 and 42 and contacts the support surfaces 41 and 42 during operation. As FIG. 5 shows, the coil spring 17 advantageously has a rectangular wire cross-section. However, a different cross-sectional form, for example a round or flattened wire cross-section, can also be advantageous. A contact surface 43, with which the coil spring 17 contacts the support surfaces 41 and 42, is formed on the inner side of the coil spring 17. On the side facing the rope drum 16, the end region of the coil spring 17 can rest with its inner periphery against the support surface 41. Advantageously, however, a distance remains between the coil spring 17 and the support surface 41 in the non-actuated state of the starter arrangement. The coil spring 17 is conically wound, with the diameter of the coil spring decreasing from the end facing the coupling unit 47 to the end facing the actuating unit 46. The contact surface 43 runs in a manner inclined at an angle α, which is advantageously between approximately 1° and approximately 10°, in relation to a parallel to the rotational axis 44 of the actuating unit 46. Thus, the coil spring 17 comes gradually into contact with the support surfaces 41 and 42 during operation. In this case, the coil spring 17 initially contacts the support surface 41 on the rope drum 16 and subsequently contacts the support surface 41 in the entrainer 24. In the non-actuated state, which is shown in FIG. 5, the coil spring 17 has a distance (c) from the support surface 41 on the end projecting into the entrainer 24.

In the embodiment shown in FIG. 6, the coil spring 17 has, in the non-actuated position shown, a distance (a) from the support surface 41 at the end projecting into the rope drum 16. On the opposite end which projects into the entrainer 24, a distance (b), which is greater than the distance (a), is formed between the contact surface 43 of the coil spring 17 and the support surface 42 of the entrainer 24. The coil spring 17 is configured cylindrically and the stubs 21 and 35 extend conically. The two stubs 21 and 35 butt against each other with their front ends, with the support surface 41 transitioning into the support surface 42. As a result, the support surfaces 41 and 42 form a straight line in every sectional plane which contains the rotational axis 44. If the ribs 22 and 36 on the stubs 21 and 35 are twisted in relation to each other, then each of the imagined extensions of support surfaces 41 and 42, that is, the conical envelope curves of the ribs 22 and 36, form straight lines with each other. As FIG. 6 also shows, the support surfaces 41 and 42 run at an angle β, which opens in the direction toward the rope drum 16 and, for example, is between approximately 1° and approximately 10°, in relation to the contact surface 43.

In the embodiment shown in FIG. 7, both the coil spring 17 and the stubs 21 and 35 extend conically. The coil spring 17 forms an angle γ, which opens in the direction toward the coupling unit 47, with a parallel to the rotational axis 44. In this case, the parallel to the rotational axis 44 intersects the coil spring 17 at its end region which projects into the rope drum 16. The support surfaces 41 and 42, together with the parallel to the rotational axis 44, enclose an angle δ which opens toward the coupling unit 47. As a result, the distance between the coil spring 17 and the support surfaces 42 and 41 increases from the actuating unit 46 to the coupling unit 47.

On account of the conical configuration, a uniform, constant change in the distance between the coil spring 17 and the stubs 35 and 21 is achieved in all three example embodiments. In each case the distance is greatest at the end facing the coupling unit 47. In the embodiment shown in FIG. 7, too, the coil spring 17 rests on the support surface 42 at its end region which projects into the entrainer 24.

A curve-shaped course of the inside diameter of the coil spring 17 or of the support surfaces 41 and 42 can also be advantageous, so that no constant change in the distance (a, b, c) is achieved. In the case of non-continuous support surfaces (41, 42), the distances are each measured in the peripheral direction in relation to an imaginary extension of the support surfaces 41 and 42. A stepped course of the support surfaces 41 and 42 can also be advantageous. As a result, the coil spring 17 contacts the support surfaces 41 and 42 in sections.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a combustion engine having a crankshaft;
a starter arrangement for starting said combustion engine;
said starter arrangement having an actuating unit and a coupling unit configured to connect to said crankshaft of said combustion engine;
said actuating unit defining a rotational axis and being rotatably mounted about said rotational axis;
a dampening element configured as a coil spring defining a working direction and being arranged between said actuating unit and said coupling unit to operate in said working direction;
said coil spring defining an interior and having an inner lying region referred to said rotational axis and said coil spring having a contact surface disposed at said inner region;
a stub projecting into said interior of said coil spring and having a radially outer region referred to said rotational axis and said stub having a support surface at said outer region;
said contact surface of said coil spring and said support surface of said stub conjointly defining a distance therebetween in at least one section of said coil spring when said starter arrangement is in a non-actuated state; and,
said distance being configured to increase in the direction of said rotational axis of said actuating unit.

2. The work apparatus of claim 1, wherein said coil spring has a first end facing toward said actuating unit and a second end facing toward said coupling unit; and, said distance changes uniformly from said first end of said coil spring to said second end of said coil spring.

3. The work apparatus of claim 1, wherein said coil spring has a first end facing toward said actuating unit and a second end facing toward said coupling unit; and, said distance decreases from said first end of said coil spring to said second end of said coil spring.

4. The work apparatus of claim 1, wherein said stub is conical.

5. The work apparatus of claim 1, wherein said coil spring is conically wound.

6. The work apparatus of claim 1, wherein said coil spring is cylindrically wound.

7. The work apparatus of claim 1, wherein said stub is a first stub arranged on said actuating unit; and, said work apparatus further comprises a second stub arranged on said coupling unit.

8. The work apparatus of claim 7, wherein said second stub has a second support surface; and, said support surface of said first stub and said second support surface of said second stub lie on a straight line in every sectional plane containing said rotational axis.

9. The work apparatus of claim 7, wherein said first stub and said second stub abut each other.

10. The work apparatus of claim 1, wherein said coil spring has a rectangular cross section.

11. The work apparatus of claim 1, wherein said coil spring has a first end with which said coil spring is held on said actuating unit and said coil spring has a second end with which said coil spring is held on said coupling unit.

12. A starter arrangement for a handheld work apparatus, the starter arrangement comprising:
a coupling unit configured to connect to a crankshaft of a combustion engine of said work apparatus;
an actuating unit defining a rotational axis and being rotatably mounted about said rotational axis;
a dampening element configured as a coil spring defining a working direction and being arranged between said actuating unit and said coupling unit to operate in said working direction;
said coil spring defining an interior and having an inner lying region referred to said rotational axis and said coil spring having a contact surface disposed at said inner region;
a stub projecting into said interior of said coil spring and having a radially outer region referred to said rotational axis and said stub having a support surface at said outer region;
said contact surface of said coil spring and said support surface of said stub conjointly defining a distance therebetween when said starter arrangement is in a non-actuated state; and,
said distance being configured to increase in the direction of said rotational axis of said actuating unit.
